(19) United States
(12) Patent Application Publication
(10) Pub. No.: US 2018/0252051 A1
(43) Pub. Date: Sep. 6, 2018

(54) WIRE ROPE SEGMENT FOR DAMPING TRANSMISSION OF CYCLIC FORCES TO A DOWNHOLE PUMP, AND A SYSTEM FOR PUMPING OIL FROM A WELL USING A WIRE ROPE SEGMENT

(71) Applicant: PROCO WELDING INC., Wabasca (CA)

(72) Inventor: Jason R. COLEMAN, Wabasca (CA)

(73) Assignee: PROCO WELDING INC.

(21) Appl. No.: 15/449,722

(22) Filed: Mar. 3, 2017

(51) Int. Cl. E21B 17/042; E21B 43/12; F04B 47/02; F04B 53/14; F16G 11/04

(52) U.S. Cl. CPC E21B 17/042; E21B 43/127; F16G 11/04; F04B 53/144; F04B 47/026

(57) ABSTRACT

A wire rope segment for damped transmission of energy from sucker rod(s) to a downhole pump. A downhole and uphole coupling member is provided at opposite ends of the segment. The coupling members each have a central longitudinal bore comprising two contiguous portions; a binding portion having an internal helically-spiraled portion for grasping and being non-rotatably secured to respective opposite ends of the segment and a coupling portion to be coupled to the downhole pump or sucker rod(s), as the case may be. In a preferred embodiment the torsional resistive force of the wire rope segment is initially less than that required to turn the rotor of the progressive cavity pump but upon twisting proportionally increases to a value greater than the torsional force required to rotate the rotor. A system for pumping oil from a well using a pump and the aforesaid wire rope segment is further disclosed.

### FIELD OF THE INVENTION

The present invention relates to a systems for pumping oil from wells using downhole pumps. More particularly, the present invention relates a component in the form of a specially-configured wire rope segment for damping transient cyclic forces otherwise transmitted to a downhole pump via sucker rods, and a system for producing oil from a well using sucker rods and a wire rope segment.

### BACKGROUND OF THE INVENTION

This background and documents mentioned below are provided for the purpose of making known information believed by the applicant to be of possible relevance to the present invention, and in particular allowing the reader to understand advantages of the invention over devices and methods known to the inventor, but not necessarily public. No admission is necessarily intended, nor should be construed as admitting, that any of the following documents or methods known to the inventor constitute legally citable and relevant prior art against the present invention.

Downhole pumps for use in vertical or deviated wells for pumping oil to surface, save and except for electric submersible pumps to which this invention does not relate, are can be of the “progressive cavity pump” or “insert pump” configuration.

In simple terms, progressive cavity pumps contain a rotor which is typically a metallic spiraled auger, which is often hardened and/or polished to increase resistance to degradation due to pumping abrasive materials. The rotor rotates in a similarly-spiraled elastomeric stator, which provides a seal with the spiraled edges of the rotor, and which allows the rotor when rotated to auger viscous oil often containing large amounts of sand and granular material to surface.

Progressive cavity pumps because of their simplicity and augering action (as opposed to a rotative action of a centrifugal pump) are particularly suited to applications where the oil is viscous and contains high amounts of abrasive sands.

Progressive cavity pumps are typically situated at a bottom of a well, and the rotor thereof is typically a male connector. Such male connector thereof is typically threadably coupled to a most downhole 1 end of continuous sucker rod or a plurality of sucker rods threadably coupled in end-to-end relation which extend from surface down the well to the downhole pump. If a plurality of sucker rods are used, such typically possess threads of a left-hand configuration which allows tightening of the coupling of such threadably-connected sucker rots when rotated uphole by a “top-drive” unit, typically one or more three-phase electric motors.

Insert pumps are another type of downhole pump used to pump oil to surface from a vertical or deviated well. Such pumps typically contain a moveable piston within a cylinder, with one or more ball valves. Typically upward movement of the piston within the cylinder expands the volume of the cylinder, and a ball of a first ball valve is drawn away from an aperture, thereby allowing oil from the bottom of the well to be drawn into the cylinder via such aperture. Pushing downwardly on the piston via sucker rods extending from uphole from an end of an oscillating pumpjack moves the ball of the first ball valve to cover the first aperture, and a second aperture in a second valve in fluid communication with the cylinder is simultaneously opened, thereby allowing the piston to force the oil uphole upon downward motion of the piston in the cylinder.

Problematically in the case of progressive cavity pumps, the point of coupling of the rotor of the progressive cavity pump to the distal end of the most downhole sucker rod is subject to transient, but relatively extreme, cyclic stresses. Such relatively extreme transient stresses typically occur at three or more specific times in a progressive cavity pump operation;
(i) at initial start up of the pump when the rotor is initially stationary and a high start-up torque is applied by the uphole top drive motors via the continuous sucker rod or plurality of coupled sucker rods;
(ii) when the progressive cavity rotor encounters from time to time “slugs” of more viscous oil, which cause a substantial jump in rotational force necessary to pump such viscous “slug” of oil to surface;
(iii) when the sucker rod(s), due to the extremely high length to cross-section ratio, and considering that the combined length possesses a relatively low stiffness, may have torsional sinusoidal waves introduced along the length thereof, the various harmonics of which may result in peaks and ebbs of rotational energy being supplied to a rotor of the pump during rotation of the downhole pump, such as at a time of stopping of the pump, when the top drive motors may cease driving the sucker rod(s) due to a power failure, or when an operator may decide to temporarily stop operating the well such as for servicing the uphole electric motors.

Each of the above, alone or in combination, typically impose alternating low and high transient torsional stresses being cyclically applied to a point of coupling of the most downhole sucker rod to the rotor of the pump. Often such alternating cyclic stresses may exceed the fatigue life of the coupling, resulting in failure of the coupling and thus inability to then operate the progressive cavity pump. Such results in high cost and expense, to say nothing of resulting lost production time, in having to trip out sucker rods and a pump from a downhole well, re-couple one to another, and re-trip such pump and sucker rods re-coupled to each other down the well to resume pumping.

Although not perhaps as pronounced, a similar problems can frequently be encountered when using insert pumps. During each oscillation of a sucker rod(s) by a pumpjack, a compressive stress is firstly applied on the piston arm of the insert pump to push the piston of the insert pump down in the cylinder (often merely by the weight of the above sucker rod). Immediately thereafter, on the upstroke of the sucker rods, an opposite tensile force is applied thereto. These alternating cyclic stresses are applied for every pumping cycle. High transient forces may similarly sometimes be encountered, when for example a viscous “slug” of oil is temporarily encountered, resulting in higher transient stresses being applied. Again, such alternating cyclic stresses being applied to the coupling may exceed the fatigue life of the coupling, resulting in failure of the coupling and thus inability to then operate the progressive cavity pump. Such results in high cost and expense, to say nothing of resulting lost production time, in having to trip out sucker rods and a pump from a downhole well, re-couple one to another, and re-trip such pump and sucker rods re-coupled to each other down the well to resume pumping.

Interposing of springs or elastomeric substances between the sucker rod and downhole pump in an effort to attempt to avoid high transitory stresses is speculated as being ineffective and potentially exacerbating the frequency of stress failures. Specifically, introducing of a spring means or elastomeric means having a spring constant within the length of sucker rods and coupling which would no doubt increase the amplitude of any torsional or compressive waves introduced along the length of such sucker rods, leading to more harmonics of potentially higher amplitudes and thus even greater transient cyclic stresses being imparted on the coupling, and thus increasing (instead of decreasing) their incidence of failures.

Various prior art patents exist to means to provide a coupling member to an end of a length of wire rope or steel cable.

U.S. Pat. No. 5,204,548 entitled “End Fittings for Wire Rope” teaches a swivelling end fitting for wire rope, which has a socket element (10), with the end of the rope (30) with splayed ends anchored in a divergent proximal bore portion (12).

U.S. Pat. No. 4,097,164 entitled “Terminals on Wire Rope and Strand” teaches an elongate terminal body having a longitudinal fore which receives a wire rope or strand. A deformable member surrounds the rope in an enlarged part of the bore. The terminal body is compressed to thereby deform the deformable body and thereby “crimp” the wire within the deformable body.

U.S. Pat. No. 8,327,506 entitled “Socketing Material and Speltered Assembly for Terminating Tensioning Member”, teaches inter alia a speltered assembly (10) having a cavity (24) into which a socketing material (16) is introduced.

U.S. Pat. No. 8,961,061 entitled “Cable Connection Systems and Methods” teaches a system for connecting two wire ropes, comprising first and second wire rope connectors, a swivel, an first and second wire ropes/cables. The first and second wire rope connectors each comprise, respectively, a base defining a chamber for receiving an end of a respective wire rope, a plug, and a cap that secures to the base to compress the plug and respective wire rope end within the chamber.

None of the foregoing patents teach use of a wire rope or steel cable to overcome problems of fatigue failures of connectors coupling downhole pumps to sucker rods.

### SUMMARY OF THE INVENTION

It is an object of the present invention to substantially reduce or eliminate instances of stress or fatigue-related failures of points of coupling of a distal end of a continuous sucker rod, or a distal end of a most downhole sucker rod of a group of sucker rods threadably coupled together in end to end relation, to downhole pumps, to thus avoid the cost and expense, to say nothing of resulting lost production time, in having to trip out such sucker rod(s) and a pump from a downhole well, re-couple one to another, and re-trip such pump and sucker rod (s) down the well in order to be able to resume pumping.

It is another broad object of the present invention to increase the mean-time-between-failure of downhole pumping componentry and their associated point of coupling to sucker rod(s).

It is a further object of the present invention to substantially reduce or eliminate instances of stress or fatigue-related failures of points of coupling of sucker rod(s) to downhole pumps.

It is a further broad object of the present invention to damp extreme transient forces experienced by downhole pumps as well as the points of coupling of such pumps to sucker rod(s) to thereby reduce peak material stresses applied to such downhole components and thereby prolong the operational life thereof.

It is a still-further broad object of the present invention to damp extreme transient forces experienced by downhole pumps as well as the points of coupling of such pumps to sucker rod(s) to thereby reduce peak material stresses applied to such downhole components and thereby prolong the operational life thereof.

The exterior of wire rope or steel cable typically consists of, for a left-hand ordinary lay wire rope, helically-wound strands which are wound in a left-hand lay around a core. Similarly, for a right-hand ordinary lay wire rope, the exterior of such wire rope or steel cable typically consists of helically-wound strands which are wound in a right-hand lay around a core.

As used herein, the term “helically-wound wire rope” or “helically-wound steel cable” means wire rope or steel cable comprised of strands of wire segments plaited or twisted together, which strands are themselves turn typically wound around a core to form a wire rope or steel cable. Strands with smaller diameter wires are typically less abrasion resistant and more fatigue resistant, while strands made up of thicker lengths of wire are typically more abrasion resistant but less fatigue resistant.

Left-hand or left-hand lay, or right hand or right hand lay, as used herein, denotes the manner in which the strands are laid to form the wire rope. Left-hand or right-hand is determined when a viewer looks at the wire rope as it points away from them. If the strands appear to turn in a clockwise direction, or like a right-hand thread as the strands progress away from the viewer, the wire rope or steel cable has a right hand lay. Conversely, if the strands appear to turn in an anti-clockwise direction, or like a left-hand thread, as the strands progress away from the viewer, the rope has a left-hand lay.

Right-hand lay strands are typically laid into a left-hand lay rope, while left-hand lay strands are typically laid into a right-hand lay wire rope.

Importantly and advantageously in the present invention, wire rope segments are typically resiliently flexible, both rotationally and transversely about a longitudinal axis. They naturally, when initially deflected via either torsional twisting or by bending about a longitudinal axis thereof when a compressive force is applied, will initially deflect but upon further twisting or deflection, become gradually more resistive to additional twisting or deflection.

The present invention makes use of this inherent property to provide a wire rope or steel cable segment that is capable of, and particularly adapted to permit, being coupled to and interposed between a sucker rod or rods (which provides energy to a downhole pump) and the downhole pump itself, to thereby damp high transient forces being applied to the point of coupling of the downhole pump and the sucker rods, and to the downhole pump itself.

The aforementioned resistive deflection property of braided wire rope acts analogous to a shock absorber and thereby damps transient extreme forces typically otherwise experienced by downhole pumps and at their respective point of coupling. Such extreme transient forces are typically experienced during pump start up, or when encountering transient “slugs” of more viscous oil to be pumped, and/or immediately at the time of stopping operation of the pump.

Thus to achieve one or more of the above objects, the present invention in a first broad embodiment comprises a system for pumping oil uphole to surface from a well, comprising:
sucker rod means extending from said surface downhole in said well;
a downhole pump, situated proximate a bottom of said well;
a resiliently-flexible helically-wound wire rope or steel cable segment, extending intermediate a most downhole end of said plurality of sucker rods and an uphole end of said downhole pump, for providing transmission of energy from said plurality of sucker rods to said downhole pump, wherein said wire rope or steel cable segment comprises:
   (i) a resiliently-flexible helically-wound wire rope
   (ii) a downhole coupling member at a downhole end of said wire rope, having a central longitudinal bore therein comprised of two contiguous portions, namely:
      (a) a binding portion, having an internal left-hand or right-hand helically-spiraled portion configured to receive therein a first end of said helically-wound wire rope; and
      (b) a coupling portion contiguous with said helically-spiraled portion for threadably coupling to said downhole pump; and
   (ii) an uphole coupling member at an uphole end of said of said wire rope, having a central longitudinal bore therein and two contiguous portions, namely:
      (a) a binding portion, having an internal left-hand or right-hand helically-spiraled portion configured so as to receive therein a second end of said wire rope mutually opposite said first end; and
      (b) a coupling portion contiguous with said helically-spiraled portion for threaded coupling to said sucker rod means.

One particular downhole pumping system which may be used in the system of the present invention and which benefits from the damping provided by the resiliently flexible wire rope segment of the present invention is a pumping system which employs a downhole insert pump as a commonly employed with surface-located pumpjacks. Insert pumps of this type are situated dowhole and utilize a reciprocating piston rod/arm coupled to a piston, which piston reciprocates in a cylinder and which by a series of valves in communication with the cylinder allows subsurface oil at a distal end of a wellbore to be pumped to surface. The reciprocation of the piston in the insert pump is typically achieved by continuous sucker rods, extending from the pumpjack downhole to the insert pump.

However, for reasons set out below, due to the present invention's ability to damp transient torsional stresses applied by the sucker rods to a downhole progressive cavity pump, it is most preferred to use the wire rope segment and system of the present invention in association with a progressive cavity pump.

Accordingly, in downhole pumping systems where the downhole pump is a progressive cavity pump, as discussed above such pumping systems typically employ a top drive motor which rotates a plurality of sucker rods or continuous sucker rod (hereinafter referred to as “sucker rod means”) which extend down a well. At a distal end of such sucker rod means such is typically coupled to a rotor of the progressive cavity pump, to thereby achieve rotation of the rotor and thus achieve the pumping action. For such a preferred application, the present invention comprises a system whereby a wire rope segment is interposed between as distal end of the sucker rod means (which in all embodiments of the system of the present invention may be a plurality of sucker rods threadably coupled to each other in end-to-end relation, or alternatively may be a single continuous sucker rod) and the rotor of the downhole pump. Accordingly, when a torsional force is applied to the wire rope or steel cable segment via the sucker rods means, opposite ends of the wire rope segment initially rotate relative to each other as the torsional resistive force of said wire rope or steel cable is initially less than a torsonal force required to rotate said rotor. However, upon further limited angular rotation (i.e. twisting”) of an end of said wire rope or steel cable segment relative to another end thereof and the rotor of the downhole pump, the torsional resistive force of the wire rope segment proportionally and gradually increases due to such twisting and the resultant uptake in “play” in the twisting of the strands, to a value which is greater than said torsional force required to rotate said rotor. The rotor of the downhole pump then commences to rotate, with the initial transient force being applied having been damped.

Further advantageously, when viscous “slugs” of oil are encountered from time to time by the progressive cavity pump which then require immediate but temporary increased rotational forces to be applied to the rotor of the pump, the same properties apply. Specifically, when a torsional “spike” force is applied to the wire rope or steel cable segment via the sucker rods due to the progressive cavity pump encountering a “slug” of viscous oil, opposite ends of the wire rope segment further rotate in a relative to each other in a damping manner as the torsional resistive force of said wire rope or steel cable is initially less than a torsonal force being rapidly applied by the sucker rods to the pump. However, upon further limited angular rotation (i.e. twisting”) of an end of said wire rope or steel cable segment relative to the rotor of the downhole pump, the torsional resistive force of said wire rope or steel cable segment proportionally and gradually increases due to such twisting and resultant uptake in “play” in the twisting of the strands, to a value which is greater than said torsional force required to rotate said rotor, and the speed of the rotor (and thus the force and rotational energy being applied to the rotor) gradually resumes to a value required to pump such “slug” of viscous oil to surface.

Likewise, in downhole pumping systems where the downhole pump is an insert pump, as discussed above such pumping systems typically employ a prime mover at surface such as a pumpjack which, via a plurality of sucker rods or continuous sucker rod which extend down a well, are connected to and continually oscillate in an up and down motion a piston rod connected to a piston which pumps oil to surface. Accordingly, at start-up of the insert pump, where the pumpjack and sucker rods provide a downward force on the piston of the insert pump, the wire rope segment is configured such that a force required to initially bend the resiliently-flexible wire rope or steel cable segment is initially less than a force required to actuate said insert pump, but after a limited amount of further bending, the force required to bend the resiliently-flexible wire rope or steel cable segment proportionally increases due to so as to become greater than a force necessary to force the piston of the insert pump downwards.

Some initial experimentation may need to be conducted, to ensure that the wire rope segment is of a diameter and tightness of plaiting such that it does not deflect to such an extent prior to overcoming the resistive force of the piston such that any significant decrease in the length of travel of the piston rod is experienced that would otherwise significantly detract from pump performance and efficiency.

Use of the present invention in insert pumps, as opposed to progressive cavity pumps is less preferred, as noted above, since in an application for insert pumps, due to the continual “up and down” motion and thus cyclic application of compressive and tensile forces to the piston of the insert pump, the wire rope will typically experience back and forth bending on each up and down stroke. The wire rope segment of the present invention must therefore necessarily be of suitable size and material strength to withstand a reasonable number of such cyclic stresses being applied thereto during each stroke of the sucker rods and piston of the insert pump. By way of contrast, where a progressive cavity pump is employed, a wire rope segment of the present invention will typically only have applied thereto a cyclic stress upon initial start up, upon slugs of oil being encountered, and possibly upon cessation of rotor rotation, which typically will result in far fewer application of cyclic stresses, and thus result in substantially longer life of the wire segment in such an application as compared to the application where a downhole insert pump is employed.

In a further refinement of the present invention, the binding portions of the coupling members at opposite ends of the wire rope segment are specifically configured, in the manner set out below, to allow non-rotational and non-displaceable coupling of such couplings to the respective opposite ends of the wire rope, and thereby allow transmission of both rotational/or compressive or tensile forces into said wire rope via the coupling members without slippage.

Specifically, in such further refinement, each of the downhole coupling member and uphole coupling member in addition to having a interior having a helically-spirally groove therein, are further of a frusto-conical shape, with the largest diameter thereof situated uphole and downhole, respectively, when the wire rope segment is in a vertical position. Accordingly, in such further refinement, the invention comprises a system for pumping oil uphole to surface from a well, comprising:
sucker rod means, extending from said surface downhole in said well;
a downhole pump, situated proximate a bottom of said well;
a resiliently-flexible wire rope or steel cable segment, extending intermediate a most downhole end of said sucker rod means and an uphole end of said downhole pump, for providing transmission of energy from said sucker rod means to said downhole pump, said wire rope or steel cable segment comprising:
   (i) a resiliently-flexible wire rope;
   (ii) a downhole coupling member at a downhole end of said wire rope or steel cable segment, having a central longitudinal bore therein comprised of two contiguous portions, namely:
      (a) a binding portion, having an internal left-hand or right-hand helically-spiraled groove on a frusto-conical portion thereof, whose largest diameter is located downhole and which helically-spiraled groove on said frusto-conical portion is configured to receive therein a first end of said wire rope; and
      (b) a coupling portion contiguous with said frusto-conical portion and having an internal thread configured to threadably receive a male connector which forms part of, or is coupled to, said downhole pump; and
   (iii) an uphole coupling member at an uphole end of said of said wire rope or steel cable segment, having a central longitudinal bore therein comprised of two contiguous portions, namely:
      (a) a binding portion, having an internal left-hand or right-hand helically-spiraled groove on a frusto-conical portion thereof, whose largest diameter is located uphole and which helically-spiraled groove on said frusto-conical portion is configured so as to receive therein a second end of said wire rope mutually opposite said first end; and
      (b) a coupling portion contiguous with said frusto-conical portion and having an internal thread configured to threadably receive a male connector which forms part of, or is coupled to, directly or indirectly, said sucker rod means.

In a further refinement, respective ends of the wire rope, when the wire rope or steel cable segment is respectively threadably secured at one end to a male connector portion of a sucker rod and an another opposite end to a male connector of a downhole pump, are compressed and forced against the respective frusto-conical portion of each the uphole and downhole coupling member, when the male connector is threadably inserted into said coupling portion of said uphole coupling member.

With such configuration effectively binding the coupling members to respect ends of the wire rope, such allows the downhole and uphole coupling members to become bound and fixedly coupled to the respective ends of the wire rope and thereby transmit all rotational or displacement energy directly to the wire rope and avoid any “slippling” or loss of transmittal of such energy to the wire rope segment.

Accordingly, in a further or alternative embodiment, when a male connector portion of a downhole pump is threadably inserted into the coupling portion of the downhole coupling member, internal threads on such downhole coupling member are configured so that a first end of the wire rope is compressed and forced against said frusto-conical portion of the downhole coupling member, to thereby better bind the first end to the frusto-conical portion of the downhole coupling member, and thereby prevent any rotation or displacement of the downhole coupling member relative to the first end.

Likewise, or alternatively, in a further preferred embodiment, when a male connector portion of a sucker rod is threadably inserted into the coupling portion of the uphole coupling member, internal threads on such uphole coupling member are configured so that the second end of the wire rope opposite the first end is compressed and forced against the frusto-conical portion of the uphole coupling member, to thereby better bind the second end to the uphole coupling member and thereby prevent any rotation or displacement of the uphole coupling member relative to the second end.

In a preferred embodiment, however, both features of the above further embodiments are incorporated. Accordingly, in such preferred embodiment the first end of the wire rope is compressed and forced against the frusto-conical portion of the downhole coupling member when the male connector of the downhole pump is threadably inserted into the coupling portion of the downhole coupling member, and likewise the second end of the wire rope is compressed and forced against the frusto-conical portion of the uphole coupling member when the male connector of a sucker rod is threadably inserted into the coupling portion of the uphole coupling member.

In a further embodiment, to accomplish pressing the second end of the wire rope against the frusto-conical portion of the uphole coupling member, the male connector which forms part of, or is coupled to, directly or indirectly, the sucker rods means, may be provided with a protuberance thereon which protrudes into the frusto-conical portion of the uphole coupling member when said male connector is threadably inserted in said coupling portion, which forces the second end of the wire rope against the frusto-conical portion to thereby aid securement of the first end of the wire rope to the uphole coupling member and thus to the sucker rod means.

Likewise, to accomplish pressing the first end of the wire rope against the frusto-conical portion of the downhole coupling member, in a further or alternative embodiment of the wire rope or steel cable segment of the present invention the male connector which forms part of, or is coupled to, directly or indirectly, the downhole pump, may be provided with a protuberance thereon which protrudes into the frusto-conical portion of the downhole coupling member when said male connector is threadably inserted in said coupling portion, which forces the first end of the wire rope segment against the frusto-conical portion of the downhole coupling member to thereby aid securement of the first end of the wire rope segment to the downhole coupling member and thus to the downhole pump.

Preferably, however, both of the above further embodiment and alternative further embodiment are incorporated. Accordingly, in a further preferred embodiment, both the male connector which forms part of a distal end of the sucker rod has a protuberance thereon which protrudes into the frusto-conical portion of the uphole coupling member when said male connector is threadably inserted in said coupling portion of said uphole coupling member, and the male connector which forms part of, or is coupled to, the downhole pump has a protuberance thereon which protrudes into said frusto-conical portion of the downhole coupling member when said male connector is threadably inserted in said coupling portion of said downhole coupling member, to thereby aid in the securement of both the first and second respective ends of the wire rope segment to the respective uphole and downhole coupling member.

In a further preferred aspect of the present invention, the invention comprises a system for pumping oil uphole to surface from a well, comprising:
sucker rod means extending from said surface downhole in said well;
a downhole pump, situated proximate a bottom of said well;
a resiliently-flexible wire rope or steel cable segment, extending intermediate a most downhole end of said sucker rod means and an uphole end of said downhole pump, for providing transmission of energy from said sucker rod means to said downhole pump, said wire rope or steel cable segment comprising:
   (i) a resiliently-flexible wire rope having a left-hand lay;
   (ii) a downhole coupling member at a downhole end of said wire rope, having a central longitudinal bore therein comprised of two contiguous portions, namely:
      (a) a binding portion, having an internal left-hand or right-hand helically-spiraled groove in a frusto-conical portion thereof, whose largest diameter is located downhole and which frusto-conical portion is configured to receive therein a first end of said wire rope; and
      (b) a coupling portion contiguous with said frusto-conical portion and having an internal thread configured to threadably receive a male connector which forms part of, or is coupled to, said downhole pump; and
   (iii) an uphole coupling member at an uphole end of said of said wire rope, having a central longitudinal bore therein comprised of two contiguous portions, namely:
      (a) a binding portion, having an internal left-hand or right-hand helically-spiraled groove in a frusto-conical portion thereof, whose largest diameter is located uphole and which helically-threaded frusto-conical portion is configured so as to receive therein a second end of said wire rope mutually opposite said first end; and
      (b) a coupling portion contiguous with said frusto-conical portion and having an internal thread configured to threadably receive a male connector which forms part of, or is coupled to, directly or indirectly, said sucker rod means;
wherein said downhole pump is a progressive cavity pump and said sucker rod means and said wire rope or steel cable segment together rotate a rotor of said progressive cavity pump to pump oil from the well to said surface; and
wherein when a torsional force is applied to said wire rope or steel cable segment coupled to said progressive cavity pump said uphole and said downhole coupling members initially become rotated relative to each other and a torsional resistive force of said wire rope is initially less than a torsonal force required to rotate said rotor but upon further limited angular rotation of an end of said wire rope or steel cable segment relative to said rotor the torsional resistive force of said wire rope or steel cable segment proportionally increases to a value which is greater than said torsional force required to rotate said rotor.

In a preferred embodiment of such further system, the binding portion of the downhole coupling member comprises an internal left-hand helically-threaded frusto-conical portion; and likewise the binding portion of the uphole coupling member comprises an internal left-hand helically-threaded frusto-conical portion.

In a further preferred embodiment of such further system, the second end of the wire rope is compressed and forced against said frusto-conical portion of said uphole coupling member when said male connector is threadably inserted into said coupling portion of said uphole coupling member.

Alternatively, or in addition, the wire rope segment is configured such that the first end of said wire rope is compressed and forced against said frusto-conical portion of said downhole coupling member when said male connector is threadably inserted into said coupling portion of said downhole coupling member.

In preferred embodiments, the male connector which forms part of, or is coupled to, directly or indirectly, the sucker rod means, has a protuberance thereon which protrudes into said frusto-conical portion of said uphole coupling member when said male connector is threadably inserted in said coupling portion of said uphole coupling member and said forces said second end of said wire rope against said frusto-conical portion of said uphole coupling member.

Alternatively, or in addition, the male connector which forms part of, or is coupled to, said downhole pump, has a protuberance thereon which protrudes into said frusto-conical portion of said downhole coupling member when said male connector is threadably inserted in said coupling portion of said downhole coupling member and forces said first end of said wire rope against said frusto-conical portion of said downhole coupling member.

In a still further aspect of the present invention the invention comprises a resiliently-flexible wire rope or steel cable segment, configured for coupling at one end thereof to a continuous sucker rod or to one end of a plurality of elongate sucker rods coupled together in end to end relation, and at another end configured to be coupled to a downhole pump, wherein said wire rope or steel cable segment when positioned in a vertically upright configuration comprises:
(i) a resiliently-flexible wire rope;
(ii) a downhole coupling member at a downhole end of said wire rope, having a central longitudinal bore therein comprised of two contiguous portions, namely:
   (a) a binding portion, having an internal left-hand or right-hand helically-spiraled groove in a frusto-conical portion thereof, whose largest diameter is located downhole and which frusto-conical portion is configured to receive therein a first end of said wire rope; and
   (b) a coupling portion contiguous with said frusto-conical portion for threadable coupling to said downhole pump; and
(ii) an uphole coupling member at an uphole end of said of said wire rope, having a central longitudinal bore therein comprised of two contiguous portions, namely:
   (a) a binding portion, having an internal left-hand or right-hand helically-spiraled groove in a frusto-conical portion thereof, whose largest diameter is located uphole and which frusto-conical portion is configured so as to receive therein a second end of said wire rope mutually opposite said first end; and
   (b) a coupling portion contiguous with said frusto-conical portion for threaded coupling to said sucker rod means.

In most progressive cavity pumps, such progressive cavity pumps rotate in a clockwise direction when viewed from above.

Accordingly, for the wire rope of the present invention when rotated by a top drive in the clockwise direction to continue to “twist” (as opposed to “untwist”), in a preferred embodiment the wire rope segment has a left-hand lay. Such left-hand lay of the wire rope segment allows the wire rope when a rotative (left-hand) rotational force is applied thereto, to become more tightly wound and therefore, like an elastic band wound between two fixed points, to apply a greater increasing rotational resistance proportional to the amount of twisting thereof.

It is further preferred that where the wire rope has a left hand lay that both the binding portion of each of the said downhole coupling member and uphole coupling member comprises an internal left-hand helically-grooved frusto-conical portion, so that the helical spiral strands on the external portion of the wire rope fit into and engage the helically-spiraled groove in each of the binding portions, to thereby best bind the wire rope to the binding portions of the downhole and uphole coupling members, and prevent any relative rotation between such two components, so that such coupling members are able to rotate maximum rotational energy into the wire rope segment without slippage. Such then allows, when a torsional force is applied to the wire rope or steel cable segment coupled to the progressive cavity pump rotor, opposite ends of the wire rope or steel cable segment initially rotate relative to each other and a torsional resistive force of said wire rope or steel cable is initially less than a torsonal force required to rotate the rotor but upon further limited angular rotation of an end of said wire rope or steel cable segment relative to the rotor the torsional resistive force of said wire rope or steel cable segment proportionally increases to a value which is greater than said torsional force required to rotate said rotor and said wire rope or steel cable segment rotates said rotor.

Where the wire rope segment of the present invention is to be used in association with a downhole insert pump, such wire rope segment is of a dimension and strength such that the force required to bend such resiliently-flexible wire rope or steel cable segment is initially less than a force required to actuate the insert pump, but after a limited amount of bending, the force required to bend the resiliently-flexible wire rope or steel cable segment proportionally increases so as to reach a point where it is greater than a force necessary to actuate said insert pump, such that said insert pump is thereby actuated after such initial damping by the wire rope segment.

The above summary of the invention does not necessarily describe all features of the invention.

For a complete description of the invention, reference is to further be had to the drawings and the detailed description of some preferred embodiments, read together with the claims.

### BRIEF DESCRIPTION OF THE DRAWINGS

Further advantages and other embodiments of the invention will now appear from the above along with the following detailed description of the various particular embodiments of the invention, taken together with the accompanying drawings each of which are intended to be non-limiting, in which:

FIG. 1 shows a schematic partial cross-sectional view of a prior art system for pumping oil from a well, using a plurality of sucker rods coupled in end to end relation, with the distal end of the most downhole sucker rod threadably and directly coupled to a rotor of a downhole progressive cavity pump;

FIG. 2 shows a schematic partial cross-sectional view of a prior system for pumping oil from a well, using a plurality of sucker rods coupled in end to end relation, with the distal end of the most downhole sucker rod threadably and directly coupled to a piston rod for moving a piston of a downhole insert pump;

FIG. 3A is a perspective view of a first embodiment of a downhole sucker rod most proximate a downhole pump, where in the prior art the present invention is not employed in conjunction with such sucker rod, and accordingly showing a typical location of failure of such sucker rod at the point of coupling to the downhole pump;

FIG. 3B is a perspective view of a second version of a downhole sucker rod most proximate a downhole pump, where in the prior art the present invention is not employed in conjunction with such sucker rod, and accordingly showing a typical location of failure of such sucker rod at the point of coupling to the downhole pump;

FIG. 4 shows a schematic view of a system of the present invention for pumping oil from a well, showing in relief “X” (in exploded view) the addition of a wire rope segment of the present invention, in a system utilizing a progressive cavity pump;

FIG. 5 shows a schematic view of a system of the present invention for pumping oil from a well, showing in relief “Y” (in exploded view) the addition of a wire rope segment of the present invention, in a system utilizing an insert pump;

FIG. 6A-6C are each respectively a side exploded perspective view of various embodiments of the resiliently-flexible wire rope or steel cable segment of the present invention;

FIG. 7A is a perspective view of one embodiment of a downhole coupling member which is used in the wire rope segment of the present invention;

FIG. 7B is a cross-sectional view through plane ‘B’-‘B’ of FIG. 7A;

FIG. 8A is a perspective view of a left-hand lay wire rope or steel cable for use in one embodiment of the present invention;

FIG. 8B is a cross-sectional view through plane ‘A’-‘A’ of FIG. 8A; and

FIGS. 9A, 9B, and 9C are side exploded views similar to FIG. 6A-6C showing various additional alternative embodiments/configurations for the wire rope segment of the present invention.

### DETAILED DESCRIPTION OF SOME PREFERRED EMBODIMENTS

In the following description, similar components in the various drawings are identified with corresponding same reference numerals.

Reference to an element in the singular, such as by use of the article “a” or “an” is not intended to mean “one and only one” unless specifically so stated, but rather “one or more”.

Reference to a “downhole” end, or an “uphole” end herein is with reference to a scenario when a wire rope segment 60, 60′, 60″, 60′″, 60^{iv} and 60^{v} of the present invention as hereinafter described is in the vertical position and when it would be in a working position in a downhole pumping system of the present invention.

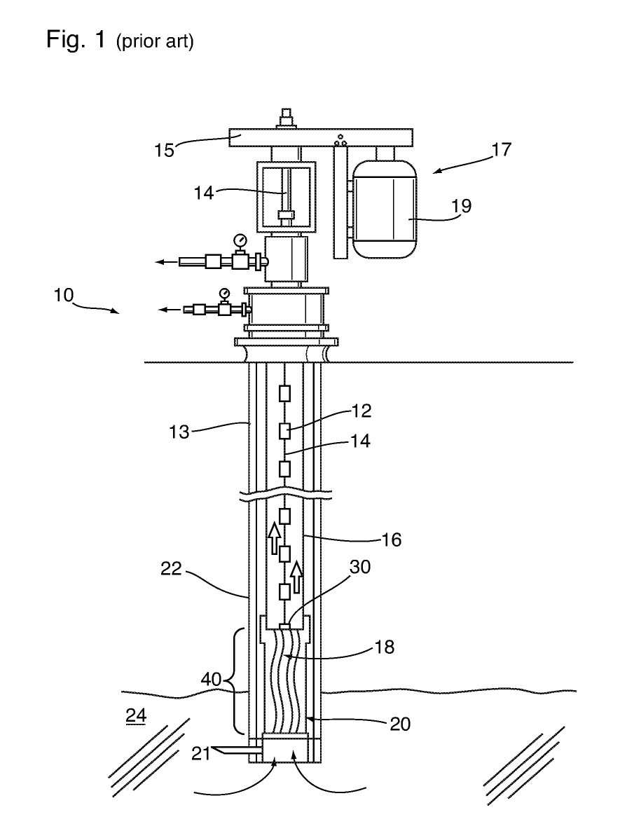

FIG. 1 shows one pumping system 10 of the prior art for pumping oil in a reservoir 24 to surface, comprising a well 13 containing casing 22.

Prior art pumping system 10 includes a downhole progressive cavity pump 40, comprising helical metallic rotor 18 surrounded by an elastomeric stator assembly 20. Sucker rods 14 are coupled together at joints 12 in end-to-end relation. Sucker rods 14 at an upper end thereof are coupled to a top drive unit 17, which comprises an electric motor 19 which via a belt or sheaves powers pulley 15, and in turn rotates sucker rods 14. A lowermost sucker rod 14 at a downhole end of such sucker rods 14 is typically threadably coupled at location ‘30” to rotor 18 of progressive cavity pump 40. A torque anchor 21 having a bore (not shown) through which oil may pass in the direction of arrows shown, may be provided at the bottom of progressive cavity pump 40 to engage the side of the casing 22 to thereby counter the torque of the pump 40 and prevent the sucker rod string 14 from becoming unscrewed. Progressive cavity pumps 40 are typically rotated by top drive 17 in a clockwise direction (when viewed from above) and the resistance to turning of the rotor 18 keeps the sucker rod string 40 tightly threadably connected to each other and prevented from being unscrewed one from another.

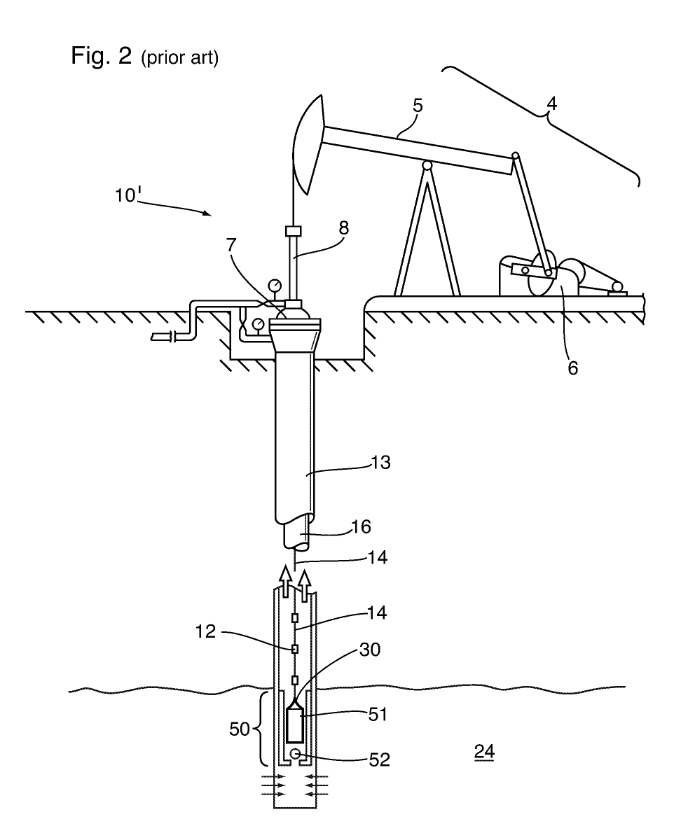

FIG. 2 shows another pumping system 10′ of the prior art for pumping oil in a reservoir 24 to surface. In alternate prior art pumping system 10′ a downhole so-called insert pump 50 is used. Insert pump 50 comprises a slidable piston 51, which is oscillated within pump body 50, and one or more ball valves 52 operate, as described in the Background of the Invention, to cause oil to be pumped uphole.

At surface, pumpjack 4 comprises a prime mover 6 and a walking beam 5 coupled to polish rod 8. Polish rod 8 in turn is coupled at the wellhead 7 to a plurality of sucker rods 14 connected in end to end relation, which extend down well 13. Well 13 is cased with steel casing 16. At a downhole end of well 13 the lowermost sucker rod 14 is threadably coupled at location ‘30’ to slidable piston 51.

In such configuration upward and downward movement of sucker rods 14 by pumpjack 4 causes piston 51 to move up and down in pump body 50 to pump oil in direction of arrows shown to surface.

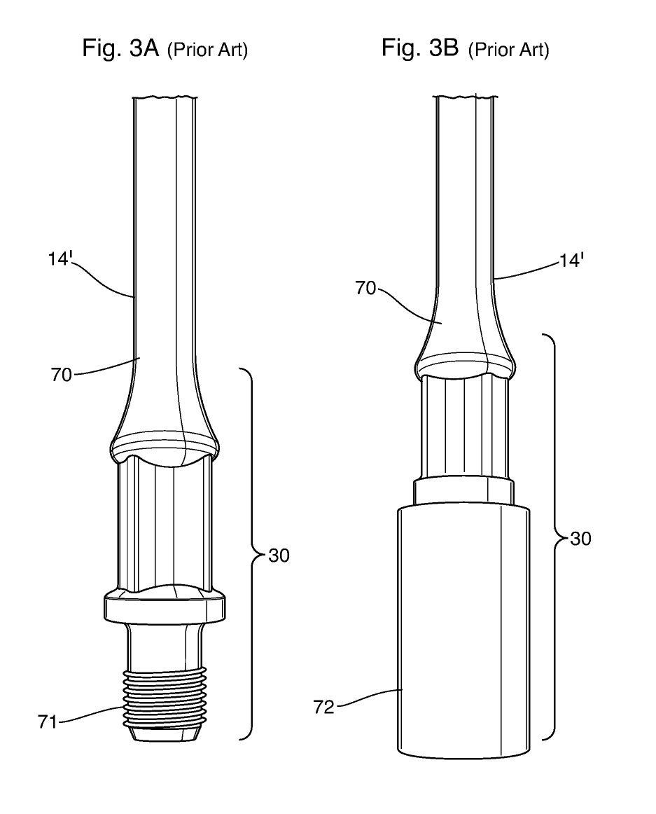

In each of the aforementioned prior art pumping systems 10, 10′, due to cyclic stresses being imparted, as described in the Background of the Invention, to the point of coupling 30 of the most downhole sucker rod 14′ to rotor 18 of progressive cavity pump 40 in the case of pumping system 10, and due to due to cyclic stresses being imparted, as described in the Background of the Invention to the point of coupling 30 of the most downhole sucker rod 14′ to oscillating piston 51 in the case of alternate pumping system 10 employing in insert pump, the lowermost sucker rod 14′ is prone to cracking 70 due to fatigue failure of the metal, in the manner shown in FIG. 3A in the case of a sucker rod 14′ having a male connector 71 at its lowermost end in the case of pumping system 10, and in the manner of fatigue failure 70 shown in FIG. 3B in the case of a sucker rod 14′ having a female internally threaded connector 72.

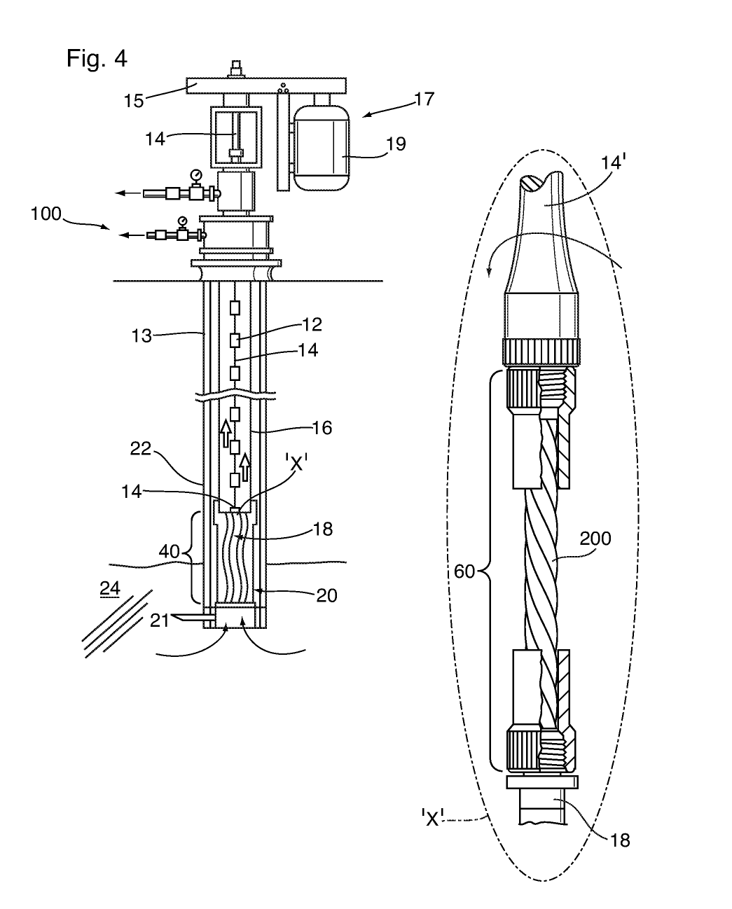

FIG. 4 shows one pumping system 100 of the present invention, similar to the system 10 for use in association with a progressive cavity pump 40 which employs a wire rope segment 60 of the present invention.

For the purposes of FIG. 4, components thereof which are identical in form and function to the components identified previously with regard to similar prior art system 10 depicted in FIG. 1 are identified with the same reference numeral, and are not further discussed.

Wire rope segment 60, shown in relief at ‘X’ in FIG. 4, is interposed at the point of connection 30 between the lowermost sucker rod 14′ and the metallic rotor 18, to thereby provide damping of extreme torsional forces which would otherwise have been experienced by both the downhole progressive cavity pump 40 and the lowermost sucker rod 14′, as explained in the Summary of the Invention.

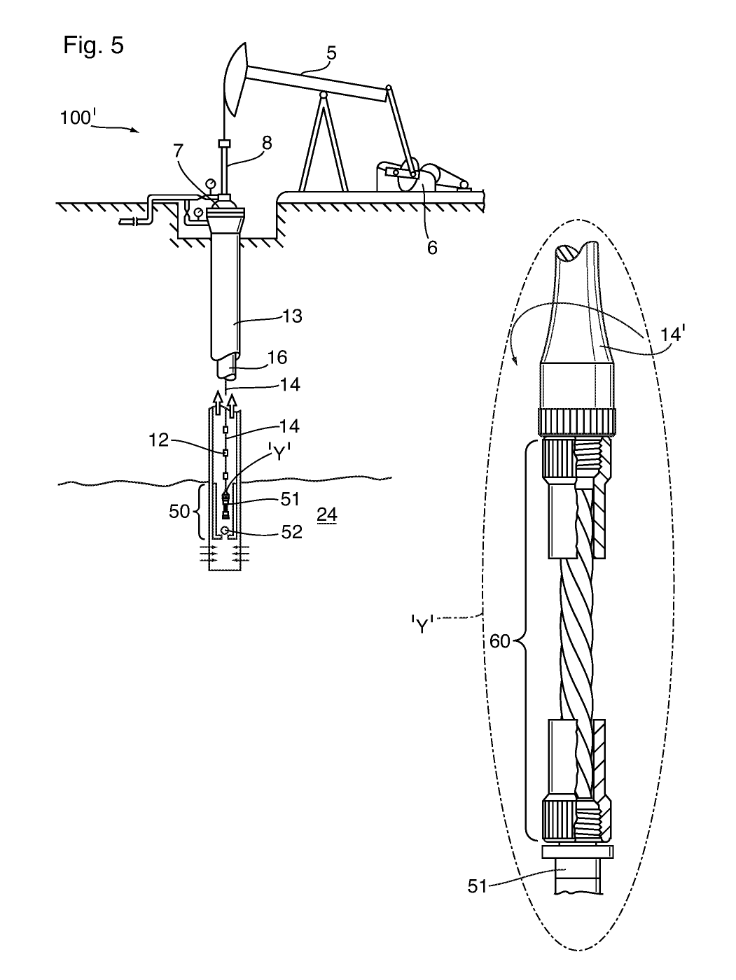

FIG. 5 shows another pumping system 100′ of the present invention, similar to the system 10′ for use in association with a downhole insert pump 50 shown in FIG. 2, which system 100′ further employs a wire rope segment 60 of the present invention.

For the purposes of FIG. 5, components thereof which are identical in form and function to the components identified previously with regard to similar prior art system 10′ depicted in FIG. 2 are identified with the same reference numeral, and are not further discussed.

Wire rope segment 60, shown in relief at ‘Y’ in FIG. 5, is interposed at the point of connection 30 between the lowermost sucker rod 14′ and the piston 51 of insert pump 50, to thereby provide damping of extreme compressive cyclic forces which would otherwise have been experienced by both the downhole insert pump 50 and equally importantly the lowermost sucker rod 14′, as explained in the Summary of the Invention.

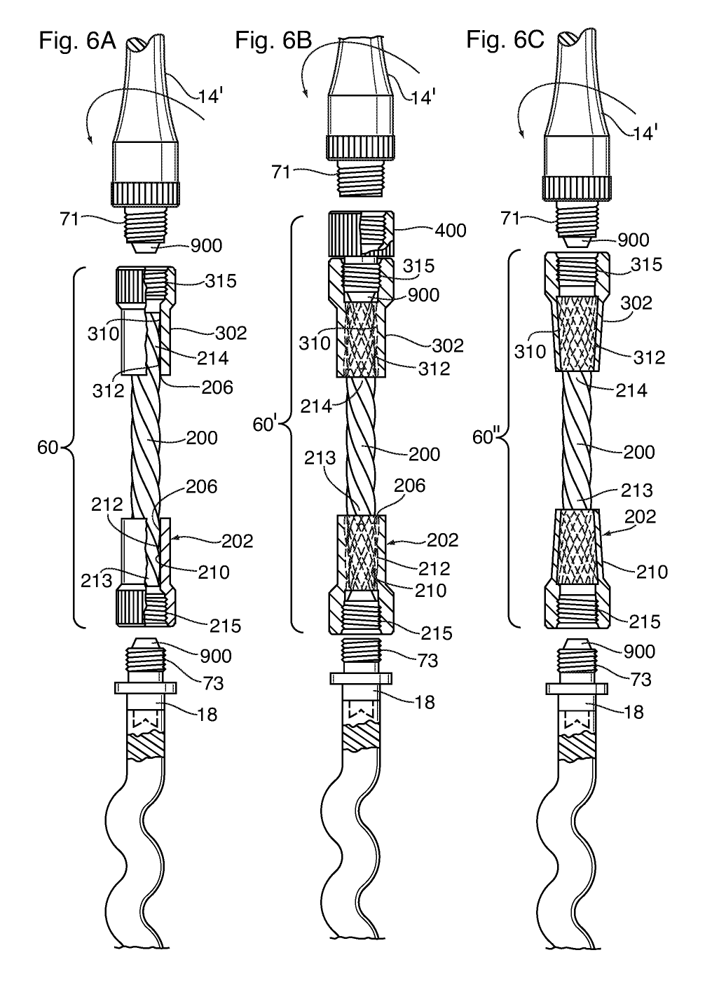

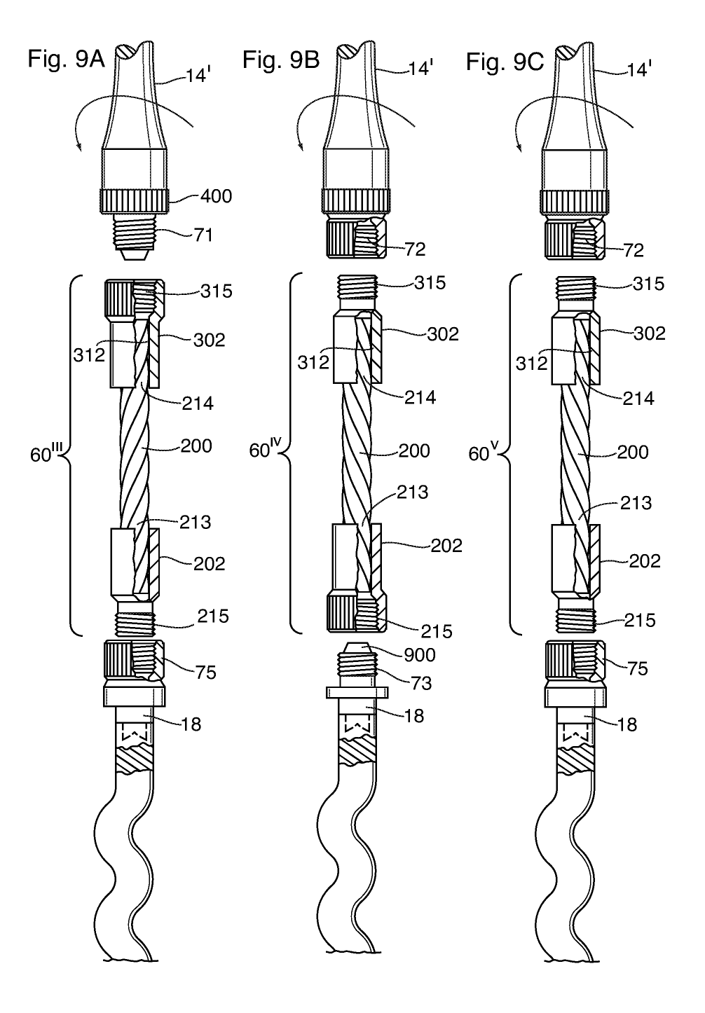

As hereinafter explained and shown in further FIGS. 6A-6C and FIGS. 9A-9C, the wire rope segment 60 as used in the pumping systems 100, 100′ of the present invention may be of a number of alternative configurations 60, 60′, 60″, 60′″, 60^{iv} and 60^{v} all of which however serve to provide an important damping of extreme torsional or compressive/tensile cyclic forces being applied to lowermost sucker rod 14′, and serve to reduce instances of fatigue failure of the lowermost sucker rod 14′.

In a first broad embodiment of the wire rope segment 60 of the present invention, as perhaps best illustrated in FIG. 6A, such wire rope segment comprises 60 a resiliently-flexible helically-wound wire rope or steel cable 200. Binded to such wire rope 200, at opposite ends thereof, is a downhole coupling member 202 and an uphole coupling member 204. Each of downhole coupling member 202 and uphole coupling member 204 have a central longitudinal bore 206 therein. Downhole coupling member 202 and uphole coupling member 204 may or may not be identical in shape (in FIGS. 6A, 6B, 6C each are identical, but in FIGS. 9A, 9B, and 9C are different from one another).

In the embodiment shown in FIG. 6A, FIG. 6A depicts the wire rope segment 60 of the present invention in the vertical position when such wire rope segment would be in an operative position when installed downhole in a pumping system 100, 100′ of the present invention. A downhole coupling member 202 is positioned at a downhole end of said wire rope 200. Downhole coupling member 202 is provided with a central longitudinal bore 206 comprised of two contiguous portions, namely (a) a binding portion 210, having an internal left-hand or right-hand helically-spiraled portion 212 configured to receive therein a first end 213 of said helically-wound wire rope or steel cable 200; and (b) a coupling portion 215 contiguous with said helically-spiraled portion 212 for coupling to downhole pump 40,50.

In addition, wire rope segment 60 further comprises an uphole coupling member 302 at an uphole end of said of said wire rope or steel cable segment, having a central longitudinal bore 206 therein and two contiguous portions, namely: (a) a binding portion 310, having an internal left-hand or right-hand helically-spiraled portion 312 configured so as to receive therein a second end 214 of said wire rope 200 mutually opposite said first end 213; and (b) a coupling portion 315 contiguous with said helically-spiraled portion 312 for coupling to said sucker rod means 14′.

First and second ends 213, 214 of wire rope 200 may be respectively binded to binding portions 210, 310 of lower and upper coupling members 202, 302 by various means known to persons of skill in the art, such as by speltering or welding.

Alternatively, such wire ends may alternatively, or in addition, be pressed against the helically-spiraled portion 212, 312 by a protuberance 900 on the male connector 71 of the sucker rod 14′, and or a similar protuberance 900 on the male connecting end of the piston 51 of an insert pump 50, or a protuberance 900 on a male connecting end 73 of the rotor 18 of a progressive cavity pump 40, to assist or bind the respective mutually opposite ends 213, 214 of wire rope 200 to the uphole and downhole coupling members 202, 302.n the manner more fully described below. Use of a protuberance 900 on

It the embodiment shown in FIG. 6B, similar components are similarly identified. A coupler 400 (in his case a male-female coupler) may be interposed between the lowermost sucker rod 14′, as shown in the wire rope segment embodiment 60′, to connect the uphole coupling member 302 to the lowermost sucker rod 14′. Sucker rod 14′ may have a male threaded end/connector 71 thereof, as showing in FIG. 3A, or an internal female threaded end/connector 72, as shown in FIG. 3B. One advantage of interposing a coupler 400 in wire rope segment 60′ is that it allows for an incremental adjustment of the combined length of the wire rope segment 60′ where it is not desired, for torsional or bending resistance reasons, to increase the length of the wire rope 200 of the wire rope segment 60′. Another advantage of interposing a coupler 400 is that a male end thereof may further have a protuberance 900 thereon which may extend into the second end 214 of wire rope 200, as shown in FIG. 6B when the coupler 400 is threadably connected to uphole coupling member 302, so that such protuberance further assists in pressing end 214 of wire rope 200 against helically-spiraled portion 312 of the binding portion of the uphole coupling member, so as to better bind uphole coupling member 302 to end 214 of wire rope 200. The aforementioned embodiment is further assisted when the binding portion 312 of uphole coupling member 302 is of a frusto-conical shape, as shown in FIG. 6C, so that when the second end 214 of wire rope is forced by protuberance 900 against helically-spiraled portion 212, thus better binding such end to the uphole coupling member 302, and as the larger diameter of the frusto-conical portion is uphole, forced expansion of end 214 into the frusto-conical portion better ensures that the uphole coupling member will not become detached from end 214 of wire rope 200.

FIG. 6C shows a preferred embodiment, namely the wire rope segment 60″, wherein the binding portion 210 of the downhole coupling member 202, and the binding portion 310 of the uphole coupling member 302, and in particular in the helically-spiraled groove portions 212, 312, thereof, have a frusto-conical portion 299, 399 respectively. Such helically grooved frusto-conical portion threadably receives the respective ends 213, 214 of wire rope 200, to assist in their becoming pressed against respective binding portions 210, 310, when effectively forced into pressed engagement by protuberances 900 on respective male end 73 of rotor 18, or male end 73 of piston 51 of an insert pump 50.

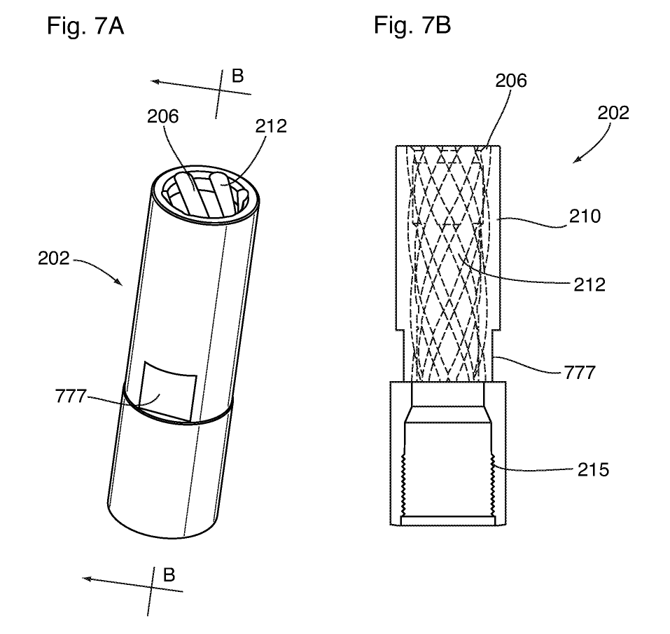

FIG. 7A and FIG. 7B show, respectively, a perspective view and a cross-section of another embodiment of the downhole coupling member 202 showing in FIGS. 6A, 6B, further having a wrench landing 777 thereon to assist in holding and tightening such coupling member 202 while the male end 73 of rotor 18 is threadably inserted in coupling portion 215 thereof.

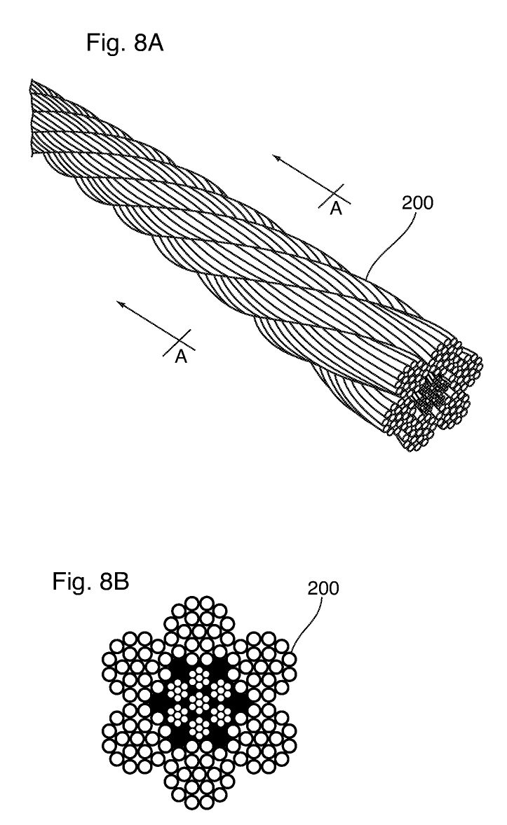

FIG. 8A shows a perspective view of the wire rope, in a preferred embodiment where the wire rope 200 has a left-hand lay, which is suitable for downhole pumps which are rotated in a clockwise direction when viewed from above, which is further particularly suited for sucker rods 14 which employ the “left hand rotation-loosen, right-hand rotation tighten” standard, which will avoid unscrewing of the sucker rods 14.

FIG. 9A shows another alternative embodiment of the wire rope segment 60′″ of the present invention. In such embodiment upper coupling member 302 has a female coupling portion 315 thereon, while downhole coupling member 202 has a male coupling portion 215 thereon, as shown. Female coupling portion 315 threadably receives a male connector 71 situated on the lowermost sucker rod 14′. If a coupler 400 is interposed between sucker rod 14′ and uphole coupling member 302, a protuberance 900 may further be provided on the male connector 71 thereof to assist in binding end 214 of wire rope 200 to uphole coupling member 302 by forcing end 214 into pressed engagement with helically-spiraled grooved portion 312 thereof. Similarly, in embodiments where rotor 18 or piston 51 may have such an internal female connector 75 thereon as shown in FIG. 9A, male coupling portion 215 maybe threadably engaged therewith to couple wire rope segment 60′″ thereto.

FIG. 9B shows another alternative embodiment of the wire rope segment 60^{iv} of the present invention. In such embodiment upper coupling member 302 has a male coupling portion 315 thereon, while downhole coupling member 202 has a female coupling portion 215 thereon, as shown. Threaded portion 315 of uphole coupling member 302 may threadably engage a female connector 72 on sucker rod 14′. Female coupling portion 215 of downhole coupling member 202 may threadably engage a male connector portion 73 of a rotor 18 or piston 51 in the case where an insert pump is used. If a coupler 400 is interposed between downhole coupling member 201 and rotor 18, a protuberance 900 may further be provided on the male connector 73 of the connector 400 which wen inserted in (female) coupling portion 215 of downhole coupling member, then serves to force end 213 of wire rope 200 to press it into downhole coupling member 302 by forcing end 214 into pressed engagement with helically-spiraled grooved portion 312 of binding portion of downhole coupling member 202.

FIG. 9C shows another alternative embodiment of the wire rope segment 60^{v} of the present invention. In such embodiment upper coupling member 302 has a male coupling portion 315 thereon, while downhole coupling member 202 has a female coupling portion 215 thereon, as shown. Threaded portion 315 of uphole coupling member 302 may threadably engage a female connector 72 on sucker rod 14′. Female coupling portion 215 may threadably encage a male connector portion 73 of a rotor 18 or piston 51 in the case where an insert pump is used. If a coupler 400 is interposed between downhole coupling member 201 and rotor 18, a protuberance 900 may further be provided on the male connector 73 of the connector 400 which wen inserted in (female) coupling portion 215 of downhole coupling member, then serves to force end 213 of wire rope 200 to press it into downhole coupling member 302 by forcing end 214 into pressed engagement with helically-spiraled grooved portion 312 of binding portion of downhole coupling member 202.

Similarly, in embodiments where rotor 18 or piston 51 may have such an internal female connector 75 thereon as shown in FIG. 9C, male coupling portion 215 maybe threadably engaged therewith to couple wire rope segment 60′″ thereto.

The above description of some embodiments of the present invention is provided to enable any person skilled in the art to make or use the present invention.

For a complete definition of the invention and its intended scope, reference is to be made to the summary of the invention and the appended claims read together with and considered with the detailed description and drawings herein on a purposive interpretation thereof.

I claim:

1. A system for pumping oil uphole to surface from a well, comprising:
sucker rod means extending from said surface downhole in said well;
a downhole pump, situated proximate a bottom of said well;
a resiliently-flexible helically-wound wire rope or steel cable segment, extending intermediate a most downhole end of said sucker rod means and an uphole end of said downhole pump, for providing transmission of energy from said sucker rod means to said downhole pump, wherein said wire rope or steel cable segment comprises:
(i) a resiliently-flexible helically-wound wire rope;
(ii) a downhole coupling member at a downhole end of said wire rope, having a central longitudinal bore therein comprised of two contiguous portions, namely:
(a) a binding portion, having an internal left-hand or right-hand helically-spiraled portion configured to receive therein a first end of said helically-wound wire rope; and
(b) a coupling portion contiguous with said helically-spiraled portion for coupling to said downhole pump;
(iii) an uphole coupling member at an uphole end of said of said wire rope, having a central longitudinal bore therein and two contiguous portions, namely:
(a) a binding portion, having an internal left-hand or right-hand helically-spiraled portion configured so as to receive therein a second end of said wire rope mutually opposite said first end; and
(b) a coupling portion contiguous with said helically-spiraled portion for coupling to said sucker rod means.

2. A system for pumping oil uphole to surface from a well, comprising:
sucker rod means, extending from said surface downhole in said well;
a downhole pump, situated proximate a bottom of said well;
a resiliently-flexible wire rope or steel cable segment, extending intermediate a most downhole end of said sucker rod means and an uphole end of said downhole pump, for providing transmission of energy from said sucker rod means to said downhole pump, said wire rope or steel cable segment comprising:
(i) a resiliently-flexible wire rope;
(ii) a downhole coupling member at a downhole end of said wire rope, having a central longitudinal bore therein comprised of two contiguous portions, namely:
(a) a binding portion, having an internal left-hand or right-hand helically-spiraled groove on a frusto-conical portion thereof, whose largest diameter is located downhole and which frusto-conical portion is configured to receive therein a first end of said wire rope; and
(b) a coupling portion contiguous with said frusto-conical portion for coupling to said downhole pump; and
(iii) an uphole coupling member at an uphole end of said of said wire rope, having a central longitudinal bore therein comprised of two contiguous portions, namely:
(a) a binding portion, having an internal left-hand or right-hand helically-spiraled groove on a frusto-conical portion thereof, whose largest diameter is located uphole and which helically-threaded frusto-conical portion is configured so as to receive therein a second end of said wire rope mutually opposite said first end; and
(b) a coupling portion contiguous with said frusto-conical portion for coupling to said sucker rod means.

3. The system for pumping oil uphole to surface as claimed in claim 1, wherein:
(i) said downhole pump is a progressive cavity pump and said sucker rod means and said wire rope or steel cable segment together rotate a rotor of said progressive cavity pump to pump oil from the well to said surface;
(ii) when a torsional force is applied to said wire rope or steel cable segment coupled to said progressive cavity pump opposite ends thereof initially rotate in a relative to each other and a torsional resistive force of said wire rope or steel cable segment is initially less than a torsonal force required to rotate said rotor but upon further limited angular rotation of an end of said wire rope or steel cable segment relative to said rotor the torsional resistive force of said wire rope or steel cable segment proportionally increases to a value which is greater than said torsional force required to rotate said rotor.

4. The system for pumping oil uphole to surface as claimed in claim 1, wherein:
(i) said downhole pump is an insert pump having a piston, and said sucker rod means and said wire rope or steel cable segment together oscillate, in an upward and downward motion, said piston by applying, respectively, a tensile and a compressive force to said piston; and
(ii) a force required to bend said resiliently-flexible wire rope or steel cable segment is initially less than a force required to actuate said insert pump, but after a limited amount of bending, said force required to bend said resiliently-flexible wire rope or steel cable segment proportionally increases so as to become greater than a force necessary to actuate said insert pump.

5. The system for pumping oil uphole to surface as claimed in claim 2, wherein:
(i) said second end of said wire rope, when a mating coupling member on said sucker rod means is threadably connected to said coupling portion of said uphole coupling member, is compressed and forced against said frusto-conical portion of said uphole coupling member.

6. The system for pumping oil uphole to surface as claimed in claim 2, wherein:
(i) said first end of said wire rope, when a mating coupling member on said downhole pump is threadably coupled to said coupling portion of said downhole coupling member, is compressed and forced against said frusto-conical portion of said downhole coupling member.

7. The system for pumping oil uphole to surface as claimed in claim 5, wherein:
(i) the mating coupling member which forms part of, or is coupled to, directly or indirectly, the sucker rod means has a protuberance thereon which protrudes into said frusto-conical portion of said uphole coupling member when said mating coupling member of said sucker rod means is threadably inserted in said coupling portion of said uphole coupling member and forces said second end of said wire rope or steel cable against said frusto-conical portion of said uphole coupling member.

8. The system for pumping oil uphole to surface as claimed in claim 6, wherein:
(i) the mating coupling member which forms part of, or is coupled to, said downhole pump, has a protuberance thereon which protrudes into said frusto-conical portion of said downhole coupling member when said mating coupling member is threadably inserted in said coupling portion of said downhole coupling member and forces said first end of said wire rope against said frusto-conical portion of said downhole coupling member.

9. The system for pumping oil uphole to surface as claimed in claim 1, wherein said downhole pump is a progressive cavity pump, and said sucker rods and said wire rope or steel cable segment together rotate a rotor of said progressive cavity pump to pump oil from the well to said surface.

10. The system for pumping oil uphole to surface as claimed in claim 1, wherein said downhole pump is an insert pump having a piston, and said plurality of sucker rods and said wire rope or steel cable segment together oscillate, in an upward and downward motion, said piston by applying, respectively, a tensile and a compressive force to said piston.

11. A resiliently-flexible wire rope or steel cable segment, configured for coupling at one end thereof to a continuous sucker rod or to one end of a plurality of elongate sucker rods coupled together in end-to-end relation, and at another end configured to be coupled to a downhole pump, wherein said wire rope or steel cable segment when positioned in a vertically upright configuration comprises:
(i) a resiliently-flexible wire rope;
(i) a downhole coupling member at a downhole end of said wire rope, having a central longitudinal bore therein comprised of two contiguous portions, namely:
(a) a binding portion, having an internal left-hand or right-hand helically-spiraled groove in a frusto-conical portion thereof, whose largest diameter is located downhole and which frusto-conical portion is configured to receive therein a first end of said wire rope; and
(b) a coupling portion contiguous with said frusto-conical portion for threadable coupling to said downhole pump; and
(ii) an uphole coupling member at an uphole end of said of said wire rope having a central longitudinal bore therein comprised of two contiguous portions, namely:
(a) a binding portion, having an internal left-hand or right-hand helically-spiraled groove in a frusto-conical portion thereof, whose largest diameter is located uphole and which helically-threaded frusto-conical portion is configured so as to receive therein a second end of said wire rope mutually opposite said first end; and
(b) a coupling portion contiguous with said frusto-conical portion for threadable coupling, directly or indirectly, to said sucker rod means.

12. The resiliently-flexible wire rope or steel cable segment as claimed in claim 11, wherein:
(i) said coupling portion of said uphole coupling member comprises an internal thread configured to threadably receive a male connector which forms part of, or is coupled to, said downhole pump; and
(ii) said coupling portion of said downhole coupling member comprises an internal thread configured to threadably receive a male connector which forms part of, or is coupled to, directly or indirectly, said sucker rod means;

13. The resiliently flexible wire rope or steel cable segment as claimed in claim 11, for rotating a rotor of a downhole progressive cavity pump, wherein:
(i) said binding portion of said downhole coupling member comprises an internal left-hand helically-spiraled groove; and
(ii) said binding portion of said uphole coupling member comprises an internal left-hand helically-spiraled groove.

14. The resiliently-flexible wire rope or steel cable segment of claim 11 for rotating a rotor of a downhole progressive cavity pump, wherein:
said wire rope has a left-hand lay;
said binding portion of each of said downhole coupling member and said uphole coupling member has an internal left hand helically-spiraled groove therein; and
wherein when a torsional force is applied to said wire rope or steel cable segment coupled to said progressive cavity pump opposite ends of said wire rope or steel cable segment initially rotate relative to each other and a torsional resistive force of said wire rope or steel cable is initially less than a torsonal force required to rotate said rotor but upon further limited angular rotation of an end of said wire rope or steel cable segment relative to said rotor the torsional resistive force of said wire rope or steel cable segment proportionally increases to a value which is greater than said torsional force required to rotate said rotor and said wire rope or steel cable segment rotates said rotor.

15. The resiliently-flexible wire rope or steel cable segment of claim 11, configured for use with a downhole insert pump, wherein a force required to bend said resiliently-flexible wire rope or steel cable segment is initially less than a force required to actuate said insert pump, but after a limited amount of bending, said force required to bend said resiliently-flexible wire rope or steel cable segment proportionally increases so as to become greater than a force necessary to actuate said insert pump.

16. A system for pumping oil uphole to surface from a well, comprising:
sucker rod means extending from said surface downhole in said well;
a downhole pump, situated proximate a bottom of said well;
a resiliently-flexible wire rope or steel cable segment, having a left-hand lay, extending intermediate a most downhole end of said sucker rod means and an uphole end of said downhole pump, for providing transmission of energy from said sucker rod means to said downhole pump, said wire rope or steel cable segment comprising:
(i) a resiliently-flexible wire rope
(ii) a downhole coupling member at a downhole end of said wire rope or steel cable segment, having a central longitudinal bore therein comprised of two contiguous portions, namely:
(a) a binding portion, having an internal left-hand or right-hand helically-spiraled groove in a frusto-conical portion thereof, whose largest diameter is located downhole and which frusto-conical portion is configured to receive therein a first end of said wire rope; and
(b) a coupling portion contiguous with said frusto-conical portion and having an internal thread configured to threadably receive a male connector which forms part of, or is coupled to, said downhole pump; and
(ii) an uphole coupling member at an uphole end of said of said wire rope or steel cable segment, having a central longitudinal bore therein comprised of two contiguous portions, namely:
(a) a binding portion, having an internal left-hand or right-hand helically-spiraled groove in a frusto-conical portion thereof, whose largest diameter is located uphole and which helically-threaded frusto-conical portion is configured so as to receive therein a second end of said wire rope mutually opposite said first end; and
(b) a coupling portion contiguous with said frusto-conical portion and having an internal thread configured to threadably receive a male connector which forms part of, or is coupled to, directly or indirectly, said sucker rod means;
wherein said downhole pump is a progressive cavity pump and said sucker rod means and said wire rope or steel cable segment together rotate a rotor of said progressive cavity pump to pump oil from the well to said surface; and
wherein when a torsional force is applied to said wire rope or steel cable segment coupled to said progressive cavity pump said uphole and said downhole coupling members initially become rotated relative to each other and a torsional resistive force of said wire rope is initially less than a torsonal force required to rotate said rotor but upon further limited angular rotation of an end of said wire relative to said rotor the torsional resistive force of said wire rope proportionally increases to a value which is greater than said torsional force required to rotate said rotor.

17. The system for pumping oil uphole to surface as claimed in claim 16, wherein:
(i) said binding portion of said downhole coupling member comprises an internal left-hand helically-threaded frusto-conical portion; and
(ii) said binding portion of said uphole coupling member comprises an internal left-hand helically-threaded frusto-conical portion.

18. The system for pumping oil uphole to surface as claimed in claim 16, wherein:
(i) said second end of said wire rope is compressed and forced against said frusto-conical portion of said uphole coupling member when said male connector is threadably inserted into said coupling portion of said uphole coupling member.

19. The system for pumping oil uphole to surface as claimed in claim 16, wherein:
(i) said first end of said wire rope is compressed and forced against said frusto-conical portion of said downhole coupling member when said male connector is threadably inserted into said coupling portion of said downhole coupling member.

20. The system for pumping oil uphole to surface as claimed in claim 19, wherein:
(i) the male connector which forms part of, or is coupled to, directly or indirectly, said sucker rod means, has a protuberance thereon which protrudes into said frusto-conical portion of said uphole coupling member when said male connector is threadably inserted in said coupling portion of said uphole coupling member and said forces said second end of said wire rope against said frusto-conical portion of said uphole coupling member.

21. The system for pumping oil uphole to surface as claimed in claim 19, wherein:
(i) the male connector which forms part of, or is coupled to, said downhole pump, has a protuberance thereon which protrudes into said frusto-conical portion of said downhole coupling member when said male connector is threadably inserted in said coupling portion of said downhole coupling member and forces said first end of said wire rope against said frusto-conical portion of said downhole coupling member.
